(19) United States
(12) Patent Application Publication
(10) Pub. No.: US 2013/0293476 A1
(43) Pub. Date: Nov. 7, 2013

(54) TOUCH INPUT DEVICE

(71) Applicants: Yu-Yen Shih, Taipei (TW); Yi-Guang Chen, Taipei (TW)

(72) Inventors: Yu-Yen Shih, Taipei (TW); Yi-Guang Chen, Taipei (TW)

(73) Assignee: PRIMAX ELECTRONICS LTD., Taipei (TW)

(21) Appl. No.: 13/607,331

(22) Filed: Sep. 7, 2012

(30) Foreign Application Priority Data
May 4, 2012 (TW) 101115933

(51) Int. Cl. G06F 3/02

(52) U.S. Cl. 345/168

(57) ABSTRACT

A touch input device includes a touch plate and a controlling unit. The touch plate comprises plural first type touch keys and at least one second type touch key. The number of second touch contacts of each second type touch key is equal to the number of the first type touch keys. The controlling unit has plural connecting ports. The number of the connecting ports is equal to the number of the first type touch keys. Each of the connecting port is connected with the corresponding second touch contacts and the corresponding first type touch key. As a consequence, the number of plural touch signals outputted from the touch input device is greater than the number of the connecting ports of the controlling unit.

### FIELD OF THE INVENTION

The present invention relates to an input device, and more particularly to a touch input device.

### BACKGROUND OF THE INVENTION

The applications of the touch input devices are gradually expanded. In the early stage, a touch input device is installed on a notebook computer. By operating the touch input device, the cursor movement may be correspondingly controlled or a corresponding icon of the user interface may be clicked without the need of a mouse to operate the notebook computer. With increasing development of science and technology, the touch input device may be applied to a touch panel. As a consequence, the display screen of a digital camera, a tablet personal computer or a smart phone may have the touch control function.

FIG. 1 schematically illustrates the structure of a conventional touch input device. As shown in FIG. 1, the conventional touch input device 1 comprises a touch plate 10, a controlling unit 11, and a printed circuit board (PCB) 12. The touch plate 10 is disposed on the printed circuit board 12. In addition, the touch plate 10 comprises plural touch keys 101. These touch keys 101 have respective touch contacts 102. The material and manufacturing process of the touch plate 10 are well known in the art, and are not redundantly described herein. The printed circuit board 12 has plural printed traces 121. The printed traces 121 are connected to the plural touch contacts 102 of the plural touch keys 101, respectively. The controlling unit 11 is disposed on the printed circuit board 12. The controlling unit 11 is connected with the plural touch contacts 102 through respective printed traces 121 of the printed circuit board 12.

After the conventional touch input device 1 is assembled, a touch key 101 of the touch plate 10 may be pressed by the user's finger. Since the electric capacity of the touching point corresponding to the pressed touch key 101 of the touch plate 10 is increased, the touch contact 102 of the pressed touch key 101 of the touch plate 10 is triggered to generate an output signal. According to the output signal, the controlling unit 11 can realize which touch contact 102 is triggered and thus generate a corresponding touch signal.

Hereinafter, the internal circuitry of the conventional touch input device will be illustrated with reference to FIG. 2. FIG. 2 is a schematic circuit block diagram illustrating the conventional touch input device. In FIG. 2, three connecting ports 111 of the controlling unit 11 and three touch contacts 102 are shown. The three connecting ports 111 comprise a first connecting port 1111, a second connecting port 1112, and a third connecting port 1113. The three touch contacts 102 comprise a first touch contact 1021, a second touch contact 1022, and a third touch contact 1023. The first connecting port 1111 is correlated with the first touch contact 1021 and connected with the first touch contact 1021. The second connecting port 1112 is correlated with the second touch contact 1022 and connected with the second touch contact 1022. The third connecting port 1113 is correlated with the third touch contact 1023 and connected with the third touch contact 1023. Take the first touch contact 1021 for example. When the first touch contact 1021 is triggered, the first touch contact 1021 generates an output signal to the first connecting port 1111. In response to the output signal from the first touch contact 1021, the controlling unit 11 may realize that the first touch contact 1021 is triggered and thus generate a touch signal corresponding to the first touch contact 1021. The operations of the second touch contact 1022 and the third touch contact 1023 are similar to those of the first touch contact 1021, and are not redundantly described herein.

Moreover, according to the practical requirements, the number of the touch keys 101 of the touch input device 1 may be increased in order to expand the function of the touch input device 1. However, since the controlling unit 11 has the limited number of connecting ports 111 and the connecting ports 111 of the controlling unit 11 are connected with the touch contacts 102 one by one, the added number of the touch keys 101 is restricted by the number of the connecting ports 111. In other words, the maximum number of the touch keys of the touch plate is equal to the number of the connecting ports of the controlling unit, and thus the functions of the touch input device 1 fails to be expanded at will.

Therefore, there is a need of providing a touch input device whose touch keys can be increased without being obviously restricted by the number of the connecting ports.

### SUMMARY OF THE INVENTION

The present invention provides a touch input device, in which only a small number of connecting ports is sufficient to generate the touch signals corresponding to a great number of touch keys.

In accordance with an aspect of the present invention, there is provided a touch input device. The touch input device includes a touch plate and a controlling unit. When the touch plate is pressed, an electric capacity of the touch plate is increased. The touch plate includes plural touch keys. The plural touch keys include M first type touch keys and at least one second type touch key. The M first type touch keys are disposed on the touch plate. Each of the M first type touch keys has one first touch contact. When one of the M first type touch keys is pressed, the corresponding first touch contact is triggered. The at least one second type touch key is disposed on the touch plate. Each of the at least one second type touch key has M separate second touch contacts. When the second type touch key is pressed, the corresponding M second touch contacts are triggered. The controlling unit is connected with the touch plate for judging whether one of the M first type touch keys and the at least one second type touch key is triggered or not. The controlling unit has M connecting ports, and each of the M connecting ports is correlated with the corresponding second touch contact and the corresponding first type touch key, so that the touch plate comprises (2^{M}−1) touch keys, wherein M is a positive integer, and a number of the first type touch keys is greater than a number of the at least one second type touch key.

In an embodiment, if the electric capacity of the touch plate is increased and the M second touch contacts are triggered, the M second touch contacts issue M high logic-level signals to the M connecting ports, respectively. In response to the M high logic-level signals, the controlling unit generates a touch signal.

In an embodiment, if the electric capacity of the touch plate is increased and one of the M first touch contacts of the M first type touch keys is triggered, the triggered first touch contact of the corresponding first type touch key issues a high logic-level signal to the corresponding connecting port. In response to the high logic-level signal and (M−1) low logic-level signal, the controlling unit generates another touch signal.

In an embodiment, if M=2, the number of the at least one second type touch key, and the connecting unit has a first connecting port and a second connecting port. The first connecting port is connected with a first one of the M second touch contacts and a first one of the M first type touch keys, and the second connecting port is connected with a second one of the M second touch contacts and a second one of the M first type touch keys.

In an embodiment, the plural touch keys further include at least one third type touch key. The at least one third type touch key is disposed on the touch plate, and each of the at least one third type touch key has (M−1) separate third touch contact contacts. When the third type touch key is pressed, the corresponding (M−1) third touch contacts are triggered, wherein the (M−1) third touch contacts of the third type touch key are connected with any (M−1) connecting ports of the M connecting ports.

In an embodiment, the touch input device further includes a printed circuit board. The printed circuit board is connected with the touch plate, and the M first touch contacts and the M separate second touch contacts are printed on the printed circuit board.

In an embodiment, the controlling unit is disposed on the printed circuit board. The M connecting ports of the controlling unit are respectively connected with the M first touch contacts and the M separate second touch contacts through plural printed traces of the printed circuit board.

In an embodiment, the touch input device includes a printed circuit board and a flexible circuit board. The flexible circuit board is connected with the printed circuit board and the controlling unit. The M first touch contacts and the M separate second touch contacts are disposed on the flexible circuit board. The M first touch contacts and the M separate second touch contacts are connected with the printed circuit board through plural conductive traces of the flexible circuit board.

In an embodiment, the controlling unit is disposed on the printed circuit board. The M connecting ports of the controlling unit are respectively connected with the M first touch contacts and the M separate second touch contacts through the plural conductive traces of the flexible circuit board.

In an embodiment, the controlling unit is disposed on the flexible circuit board. The M connecting ports of the controlling unit are respectively connected with the M first touch contacts, the M separate second touch contacts and the printed circuit board through the plural conductive traces of the flexible circuit board.

In an embodiment, the plural touch keys have respective key patterns, and the key patterns are disposed on a surface of the touch plate. The functions of respective touch keys are recognizable through the key patterns.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the structure of a conventional touch input device;

FIG. 2 is a schematic circuit block diagram illustrating the conventional touch input device;

FIG. 3 is a schematic exploded view illustrating a touch input device according to a first embodiment of the present invention;

FIG. 4 is a schematic circuit block diagram illustrating the touch input device according to the first embodiment of the present invention;

FIG. 5 is a schematic exploded view illustrating a touch input device according to a second embodiment of the present invention;

FIG. 6 is a schematic circuit block diagram illustrating the touch input device according to the second embodiment of the present invention; and

FIG. 7 is a schematic exploded view illustrating a touch input device according to a third embodiment of the present invention.

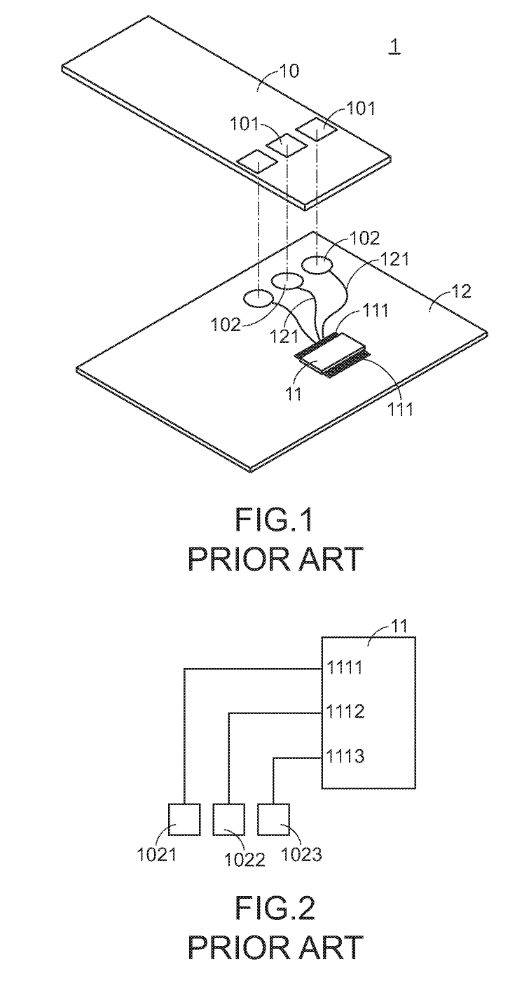

### DETAILED DESCRIPTION OF THE PREFERRED EMBODIMENT

For obviating the drawbacks encountered from the prior art, the present invention provides a touch input device.

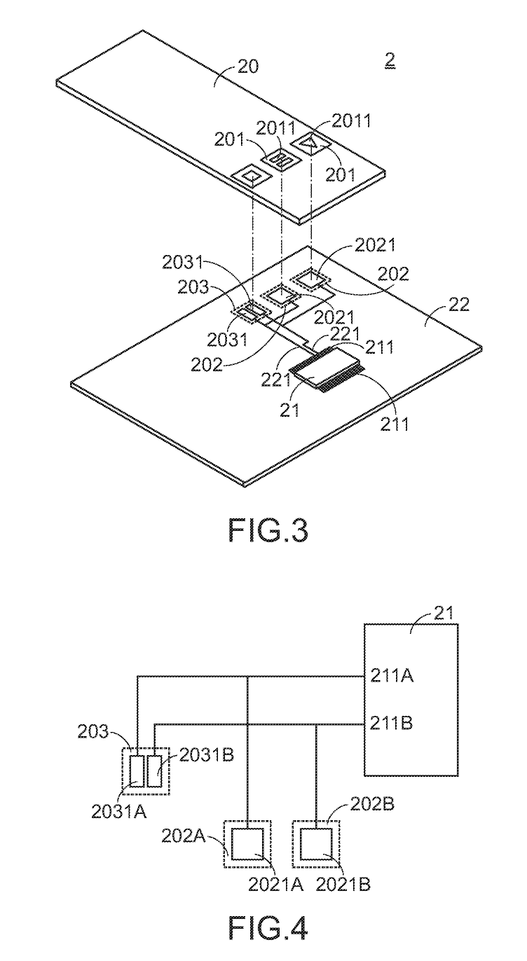

FIG. 3 is a schematic exploded view illustrating a touch input device according to a first embodiment of the present invention. As shown in FIG. 3, the touch input device 2 comprises a touch plate 20, a controlling unit 21, and a printed circuit board 22. The touch plate 20 is disposed on the printed circuit board 22. When the touch plate 20 is pressed, the electric capacity of the touch plate 20 is increased. In addition, the touch plate 20 comprises plural touch keys 201. The touch keys 201 have respective key patterns 2011. The key patterns 2011 are disposed on a surface of the touch plate 20. Through the key patterns 2011, the user may recognize the functions of respective touch keys 201. In addition, the plural touch keys 201 are divided into M first type touch keys 202 and at least one second type touch key 203. The number of the first type touch keys 202 is greater than the number of the at least one second type touch key 203. The first type touch keys 202 and the at least one second type touch key 203 are all disposed on the touch plate 20. As the electric capacity of the touching point corresponding to the pressed touch key of the touch plate 20 is increased, the corresponding touch key is triggered. Moreover, each of the first type touch keys 202 has a first touch contact 2021. That is, the M first type touch keys 202 have a total of M first touch contacts 2021. Each second type touch key 203 has M separate second touch contacts 2031. These M second touch contacts 2031 are collaboratively defined as one second type touch key 203. Each of the M second touch contacts 2031 is dependent. That is, each of the M second touch contacts 2031 is not connected with any other second touch contacts 2031. In this embodiment, M is equal to 2. In other words, the plural touch keys 201 comprise two first type touch keys 202 and one second type touch key 203.

In this embodiment, the touch key with a single touch contact is defined as the first type touch key 202, and the touch key with two touch contacts is defined as the second type touch key 203.

Please refer to FIG. 3 again. The printed circuit board 22 has plural printed traces 221. The printed circuit board 22 is connected with the touch plate 20 through the plural printed traces 221. Each printed trace 221 is connected with a corresponding first touch contact 2021 or a corresponding second touch contact 2031. In addition, two first touch contacts 2021 and two separate second touch contacts 2031 are printed on the printed circuit board 22. The controlling unit 21 is disposed on the printed circuit board 22. Through the plural printed traces 221 of the printed circuit board 22, the controlling unit 21 is connected with the touch plate 20. The controlling unit 21 is used for detecting whether the electric capacity of the touch plate 20 is increased, thereby judging whether the two first type touch keys 202 and the second type touch key 203 are triggered. The controlling unit 21 has plural connecting ports 211, wherein only M connecting ports 211 are available (see FIG. 4). The M connecting ports 211 are respectively connected to the M second touch contacts 2031 and the M first type touch keys 202 through the plural printed traces 221 of the printed circuit board 22.

Hereinafter, the internal circuitry of the touch input device 2 will be illustrated with reference to FIG. 4. FIG. 4 is a schematic circuit block diagram illustrating the touch input device according to the first embodiment of the present invention. In FIG. 4, two connecting ports 211 of the controlling unit 21, two first touch contacts 2021 and two separate second touch contacts 2031 are shown. The two connecting ports 211 are correlated with the two second touch contacts 2031 and the two first type touch keys 202, respectively. For discrimination, a first one of the two connecting ports 211 is designated as 211A, and a second one of the two connecting ports 211 is designated as 211B. Similarly, the first one of the two first touch contacts 2021 is designated as 2021A, and the second one of the two first touch contacts 2021 is designated as 2021B. Similarly, the first one of the two second touch contacts 2031 is designated as 2031A, and the second one of the two second touch contacts 2031 is designated as 2031B. As shown in FIG. 4, the connecting port 211A is connected with the first touch contact 2021A and the second touch contact 2031A, and the connecting port 211B is connected with the first touch contact 2021B and the second touch contact 2031B. The first touch contact 2021A is correlated with the first one of the first type touch keys 202 (designated as 202A), and the first touch contact 2021B is correlated with the second one of the first type touch keys 202 (designated as 202B). The second touch contact 2031A and the second touch contact 2031B are collaboratively correlated with the second type touch key 203.

When the first type touch key 202A is pressed by the user, the electric capacity of the touching point corresponding to the pressed first type touch key 202A of the touch plate 20 is increased. Consequently, the first touch contact 2021A is triggered to generate a high logic-level signal to the connecting port 211A. The high logic-level signal (i.e. the logic state=1) is transmitted to the controlling unit 21 through the connecting port 211A. Since no signal is transmitted to the controlling unit 21 through the connecting port 211B, the controlling unit 21 may consider that the first touch contact 2021B issues a low logic-level signal (i.e. the logic state=0). In response to the logic-level signal (1, 0), the controlling unit 21 generates a first touch signal corresponding to the first type touch key 202A. Similarly, when the first type touch key 202B is pressed by the user, the electric capacity of the touching point corresponding to the pressed first type touch key 202B of the touch plate 20 is increased. Consequently, the first touch contact 2021B is triggered to generate a high logic-level signal to the connecting port 211B. The high logic-level signal is transmitted to the controlling unit 21 through the connecting port 211B. Since no signal is transmitted to the controlling unit 21 through the connecting port 211A, the controlling unit 21 may consider that the first touch contact 2021A issues a low logic-level signal. In response to the logic-level signal (0, 1), the controlling unit 21 generates a second touch signal corresponding to the first type touch key 202B.

Moreover, when the second type touch key 203 is pressed by the user, the electric capacity of the touching point corresponding to the pressed second type touch key 203 of the touch plate 20 is increased. Under this circumstance, the separate second touch contacts 2031A and 2031B are both triggered to generate two high logic-level signals to the connecting ports 211A and 211B, respectively. That is, the two high logic-level signals are transmitted to the controlling unit 21 through the connecting ports 211A and 211B, respectively. In response to the logic-level signal (1, 1), the controlling unit 21 generates a third touch signal corresponding to the second type touch key 203.

From the above discussions, the touch input device 2 of the present invention has a specified circuitry configuration. That is, the connecting port 211A is connected with the first touch contact 2021A and the second touch contact 2031A, and the connecting port 211B is connected with the first touch contact 2021B and the second touch contact 2031B. Due to the circuitry configuration of the touch input device 2, only two connecting ports 211 of the controlling unit 21 are sufficient to generate three touch signals corresponding to three touch keys (i.e. the first type touch key 202A, the first type touch key 202B and the second type touch key 203). In other words, if the controlling unit 21 has M connecting ports, the above circuitry configuration may generate (2^{M}−1) touch signals corresponding to (2^{M}−1) touch keys.

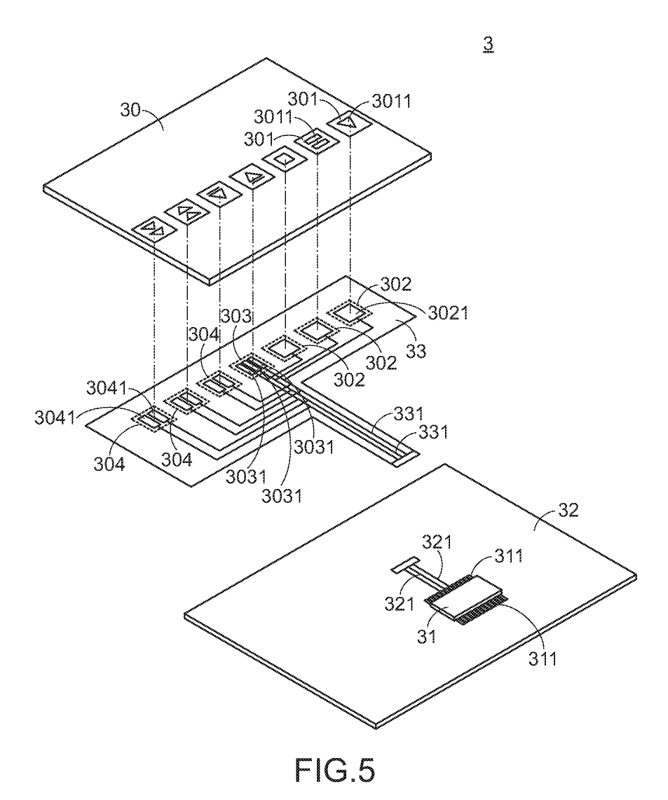

The present invention further comprises a second embodiment of a touch input device. FIG. 5 is a schematic exploded view illustrating a touch input device according to a second embodiment of the present invention. As shown in FIG. 5, the touch input device 3 comprises a touch plate 30, a controlling unit 31, a printed circuit board 32, and a flexible circuit board (FPC) 33. The touch plate 30 is disposed on the flexible circuit board 33. When the touch plate 30 is pressed, the electric capacity of the touch plate 30 is increased. In addition, the touch plate 30 comprises plural touch keys 301. The touch keys 301 have respective key patterns 3011. The key patterns 3011 are disposed on a surface of the touch plate 30. Through the key patterns 3011, the user may recognize the functions of respective touch keys 301. In addition, the plural touch keys 301 are divided into M first type touch keys 302, at least one second type touch key 303, and at least one second type touch key 304. The number of the first type touch keys 302 is greater than the number of the at least one second type touch key 303, and the number of the at least one third type touch key 304 is also greater than the number of the at least one second type touch key 303.

The first type touch keys 302, the at least one second type touch key 303 and the at least one second type touch key 304 are all disposed on the touch plate 30. As the electric capacity of the touching point corresponding to the pressed touch key of the touch plate 20 is increased, the corresponding touch key is triggered. Moreover, each of the first type touch keys 302 has a first touch contact 3021. That is, the M first type touch keys 302 have a total of M first touch contacts 3021. Each second type touch key 303 has M second touch contacts 3031, which are separated from each other. Each third type touch key 304 has (M−1) third touch contacts 3041, which are separated from each other. In this embodiment, M is equal to 3. In other words, the plural touch keys 301 comprise three first type touch keys 302, one second type touch key 303 and three third type touch keys 304.

In this embodiment, the touch key with the a single touch contact is defined as the first type touch key 302, the touch key with three touch contacts is defined as the second type touch key 303, and the touch key with two touch contacts is defined as the third type touch key 304.

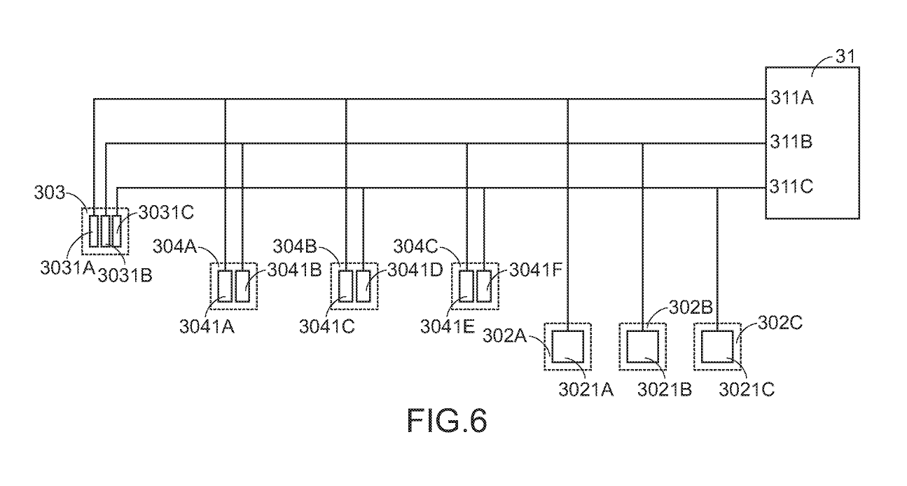

Please refer to FIG. 5 again. The flexible circuit board 33 is connected with the printed circuit board 32 and the touch plate 30. The flexible circuit board 33 has plural conductive traces 331. The flexible circuit board 33 is connected with the touch plate 30 through the plural conductive traces 331. Each conductive trace 331 is connected with a corresponding first touch contact 3021, a corresponding second touch contact 3031 or a corresponding third touch contact 3041. In addition, three first touch contacts 3021, three separate second touch contacts 3031 and six separate third touch contacts 3041 are connected with the printed circuit board 32 through the plural conductive traces 331. The controlling unit 31 is disposed on the printed circuit board 32. Through the plural conductive traces 331 of the flexible circuit board 33, the controlling unit 31 is connected with the touch plate 30. The controlling unit 31 is used for detecting whether the electric capacity of the touch plate 30 is increased, thereby judging whether one of the touch keys 301 is triggered. The controlling unit 31 has plural connecting ports 311, wherein only M connecting ports 311 are available (see FIG. 6). The M connecting ports 311 are respectively connected to the M second touch contacts 3031, M×(M−1) third touch contacts 3041 and the M first type touch keys 302 through the plural conductive traces 331 of the flexible circuit board 33.

Hereinafter, the internal circuitry of the touch input device 3 will be illustrated with reference to FIG. 6. FIG. 6 is a schematic circuit block diagram illustrating the touch input device according to the second embodiment of the present invention. In FIG. 6, three connecting ports 311 of the controlling unit 31, three first touch contacts 3021, three separate second touch contacts 3031 and six separate third touch contacts 3041 are shown. The three connecting ports 311 are correlated with the three second touch contacts 3031, the three first type touch keys 302 and the three third type touch keys 304, respectively. For discrimination, a first one of the three connecting ports 311 is designated as 311A, a second one of the three connecting ports 311 is designated as 311B, and a third one of the three connecting ports 311 is designated as 311C. Similarly, the first one of the three first touch contacts 3021 is designated as 3021A, the second one of the three first touch contacts 3021 is designated as 3021B, and the third one of the three first touch contacts 3021 is designated as 3021C. Similarly, the three second touch contacts 3031 are designated as 3031A, 3031B and 3031C, respectively. Similarly, the six third touch contacts 3041 are designated as 3041A, 3041B, 3041C, 3041D, 3041E and 3041F, respectively.

As shown in FIG. 6, the connecting port 311A is connected with the first touch contact 3021A, the third touch contact 3041A, the third touch contact 3041C and the second touch contact 3031A. Moreover, the connecting port 311B is connected with the first touch contact 3021B, the third touch contact 3041B, the third touch contact 3041E and the second touch contact 3031B. Moreover, the connecting port 311C is connected with the first touch contact 3021C, the third touch contact 3041C, the third touch contact 3041F and the second touch contact 3031C. The first touch contact 3021A is correlated with the first one of the first type touch keys 302 (designated as 302A), the first touch contact 3021B is correlated with the second one of the first type touch keys 302 (designated as 302B), and first touch contact 3021C is correlated with the third one of the first type touch keys 302 (designated as 302C). The third touch contact 3041A and the third touch contact 3041B are collaboratively correlated with the first one of the third type touch keys 304 (designated as 304A). The third touch contact 3041C and the third touch contact 3041D are collaboratively correlated with the second one of the third type touch keys 304 (designated as 304B). The third touch contact 3041E and the third touch contact 3041F are collaboratively correlated with the third one of the third type touch keys 304 (designated as 304C). The second touch contact 3031A, the second touch contact 3031B and the second touch contact 3031C are collaboratively correlated with the second type touch key 303.

When the first type touch key 302A is pressed by the user, the electric capacity of the touching point corresponding to the pressed first type touch key 302A of the touch plate 30 is increased. Consequently, the first touch contact 3021A is triggered to generate a high logic-level signal to the connecting port 311A. The high logic-level signal (i.e. the logic state=1) is transmitted to the controlling unit 31 through the connecting port 311A. Since no signal is transmitted to the controlling unit 31 through the connecting port 311B and the connecting port 311C, the controlling unit 31 may consider that each of the first touch contact 3021B and the first touch contact 3021C issues a low logic-level signal (i.e. the logic state=0). In response to the logic-level signal (1, 0, 0), the controlling unit 31 generates a first touch signal corresponding to the first type touch key 302A. Similarly, when the first type touch key 302B is pressed by the user, in response to the logic-level signal (0, 1, 0), the controlling unit 31 generates a second touch signal corresponding to the first type touch key 302B. Similarly, when the first type touch key 302C is pressed by the user, in response to the logic-level signal (0, 0, 1), the controlling unit 31 generates a third touch signal corresponding to the first type touch key 302C.

Moreover, when the second type touch key 303 is pressed by the user, the electric capacity of the touching point corresponding to the pressed second type touch key 303 of the touch plate 30 is increased. Under this circumstance, the separate second touch contacts 3031A, 3031B and 3031C are all triggered to generate three high logic-level signals to the connecting ports 311A, 311B and 311C, respectively. That is, the three high logic-level signals (i.e. the logic state=0) are transmitted to the controlling unit 31 through the connecting ports 311A, 311B and 311C, respectively. In response to the logic-level signal (1, 1, 1), the controlling unit 31 generates a fourth touch signal corresponding to the second type touch key 303.

Moreover, when the third type touch key 304A is pressed by the user, the electric capacity of the touching point corresponding to the pressed third type touch key 304A of the touch plate 30 is increased. Under this circumstance, the separate third touch contacts 3041A and 3041B are all triggered to generate two high logic-level signals to the connecting ports 311A and 311B, respectively. That is, the two high logic-level signals (i.e. the logic state=0) are transmitted to the controlling unit 31 through the connecting ports 311A and 311B, respectively. Since no signal is transmitted to the controlling unit 31 through the connecting port 311C, the controlling unit 31 may consider that the third touch contact 3041C issues a low logic-level signal (i.e. the logic state=0). In response to the logic-level signal (1, 1, 0), the controlling unit 31 generates a fifth touch signal corresponding to the third type touch key 304A. Similarly, when the third type touch key 304B is pressed by the user, the electric capacity of the touching point corresponding to the pressed third type touch key 304B of the touch plate 30 is increased. In response to the logic-level signal (1, 0, 1), the controlling unit 31 generates a sixth touch signal corresponding to the third type touch key 304B. Similarly, when the third type touch key 304C is pressed by the user, the electric capacity of the touching point corresponding to the pressed third type touch key 304C of the touch plate 30 is increased. In response to the logic-level signal (0, 1, 1), the controlling unit 31 generates a seventh touch signal corresponding to the third type touch key 304C. From the above discussions, due to the circuitry configuration of the touch input device 3, only three connecting ports 311 of the controlling unit 31 are sufficient to generate seven touch signals.

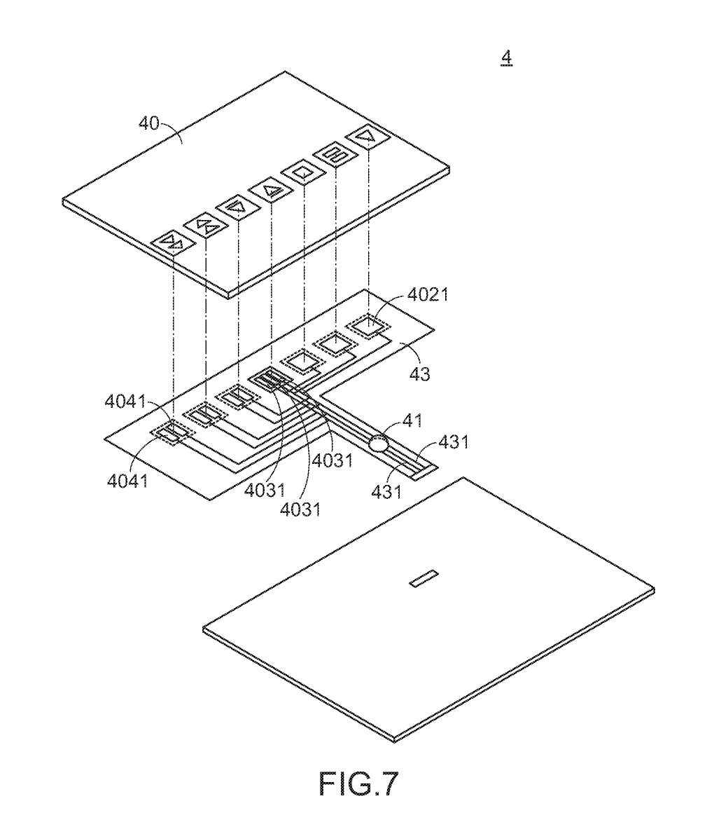

The present invention further comprises a third embodiment of a touch input device. FIG. 7 is a schematic exploded view illustrating a touch input device according to a third embodiment of the present invention. As shown in FIG. 7, the touch input device 4 comprises a touch plate 40, a controlling unit 41, a printed circuit board 42, and a flexible circuit board 43. The functions and the structures of the touch plate 40, the controlling unit 41, the printed circuit board 42 and the flexible circuit board 43 are similar to those of the touch input device 3 of the second embodiment, and are not redundantly described herein. In comparison with the touch input device 3, the controlling unit 41 of the touch input device 4 is disposed on the flexible circuit board 43. In addition, the M connecting ports (not shown) of the controlling unit 41 are respectively connected to M first touch contacts 4021, M separate second touch contacts 4031, M×(M−1) separate third touch contacts 4041 and the printed circuit board 42 through the plural conductive traces 431 of the flexible circuit board 43.

From the above discussions, the touch input device of the present invention has a specified circuitry configuration, wherein each connecting port is connected with a corresponding first touch contact and a corresponding second touch contact. Due to the circuitry configuration of the touch input device, only M available connecting ports of the controlling unit are sufficient to generate (2^{M}−1) touch signals corresponding to (2^{M}−1) touch keys. In order words, only a small number of connecting ports of the controlling unit is sufficient to generate the touch signals corresponding to a great number of touch keys. As a consequence, the function of the touch input device of the present invention is expanded.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touch input device, comprising:
a touch plate, wherein when said touch plate is pressed, an electric capacity of said touch plate is increased, wherein said touch plate comprises plural touch keys, and said plural touch keys comprises:
M first type touch keys disposed on said touch plate, wherein each of said M first type touch keys has one first touch contact, wherein when one of said M first type touch keys is pressed, said corresponding first touch contact is triggered; and
at least one second type touch key disposed on said touch plate, wherein each of said at least one second type touch key has M separate second touch contacts, wherein when said second type touch key is pressed, said corresponding M second touch contacts are triggered; and
a controlling unit connected with said touch plate for judging whether one of said M first type touch keys and said at least one second type touch key is triggered or not, wherein said controlling unit has M connecting ports, and each of said M connecting ports is correlated with said corresponding second touch contact and said corresponding first type touch key, so that said touch plate comprises (2^{M}−1) touch keys, wherein M is a positive integer, and a number of said first type touch keys is greater than a number of said at least one second type touch key.

2. The touch input device according to claim 1, wherein if said electric capacity of said touch plate is increased and said M second touch contacts are triggered, said M second touch contacts issue M high logic-level signals to said M connecting ports, respectively, wherein in response to said M high logic-level signals, said controlling unit generates a touch signal.

3. The touch input device according to claim 1, wherein if said electric capacity of said touch plate is increased and one of said M first touch contacts of said M first type touch keys is triggered, said triggered first touch contact of said corresponding first type touch key issues a high logic-level signal to said corresponding connecting port, wherein in response to said high logic-level signal and (M−1) low logic-level signal, said controlling unit generates another touch signal.

4. The touch input device according to claim 1, wherein if M=2, said number of said at least one second type touch key, and said connecting unit has a first connecting port and a second connecting port, wherein said first connecting port is connected with a first one of said M second touch contacts and a first one of said M first type touch keys, and said second connecting port is connected with a second one of said M second touch contacts and a second one of said M first type touch keys.

5. The touch input device according to claim 1, wherein said plural touch keys further comprise at least one third type touch key, wherein said at least one third type touch key is disposed on said touch plate, and each of said at least one third type touch key has (M−1) separate third touch contact contacts, wherein when said third type touch key is pressed, said corresponding (M−1) third touch contacts are triggered, wherein said (M−1) third touch contacts of said third type touch key are connected with any (M−1) connecting ports of said M connecting ports.

6. The touch input device according to claim 1, further comprising a printed circuit board, wherein said printed circuit board is connected with said touch plate, and said M first touch contacts and said M separate second touch contacts are printed on said printed circuit board.

7. The touch input device according to claim 6, wherein said controlling unit is disposed on said printed circuit board, wherein said M connecting ports of said controlling unit are respectively connected with said M first touch contacts and said M separate second touch contacts through plural printed traces of said printed circuit board.

8. The touch input device according to claim 1, further comprising:
a printed circuit board; and
a flexible circuit board connected with said printed circuit board and said controlling unit, wherein said M first touch contacts and said M separate second touch contacts are disposed on said flexible circuit board, wherein said M first touch contacts and said M separate second touch contacts are connected with said printed circuit board through plural conductive traces of said flexible circuit board.

9. The touch input device according to claim 8, wherein said controlling unit is disposed on said printed circuit board, wherein said M connecting ports of said controlling unit are respectively connected with said M first touch contacts and said M separate second touch contacts through said plural conductive traces of said flexible circuit board.

10. The touch input device according to claim 8, wherein said controlling unit is disposed on said flexible circuit board, wherein said M connecting ports of said controlling unit are respectively connected with said M first touch contacts, said M separate second touch contacts and said printed circuit board through said plural conductive traces of said flexible circuit board.

11. The touch input device according to claim 1, wherein said plural touch keys have respective key patterns, and said key patterns are disposed on a surface of said touch plate, wherein functions of respective touch keys are recognizable through said key patterns.
